(19) United States
(12) Patent Application Publication
(10) Pub. No.: US 2018/0123631 A1
(43) Pub. Date: May 3, 2018

(54) (Smartphone) Camera Cover Case Specifications

(71) Applicant: Tamim Mohammad Hessabi, Glendale, CA (US)

(72) Inventor: Tamim Mohammad Hessabi, Glendale, CA (US)

(21) Appl. No.: 15/339,890

(22) Filed: Oct. 31, 2016

(51) Int. Cl. H04B 1/3888; H04M 1/02

(52) U.S. Cl. CPC H04B 1/3888; H04M 1/0202

(57) ABSTRACT

The New art to a smartphone Case is the design and idea to cover the front and rear cameras of a smartphone manually via sliding cover over the smartphone front and rear cameras. There are currently no such smartphone case in the marketplace. To the best of my knowledge and believe, this design to a smartphone case to cover the front and rear cameras is original and by me, Tamim M. Hessabi.

### BRIEF SUMMARY AND BACKGROUND

The Camera Cover Case design is intended for added protection of the Smartphone Front and Rear Cameras from scratch, damage and privacy security. This smartphone Case will have an added camera cover feature by the cameras where you can slide a cover over the front and rear cameras of the Smartphone for protection and privacy reasons.

### DESCRIPTION OF INVENTION

The added feature to a smartphone Case is simple in design, practical, solves a problem and original.

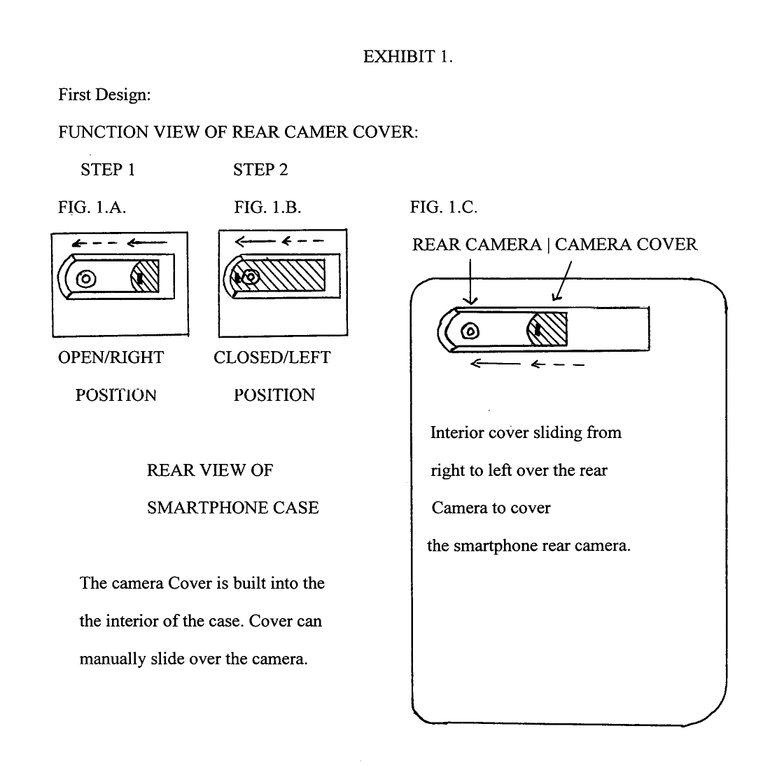

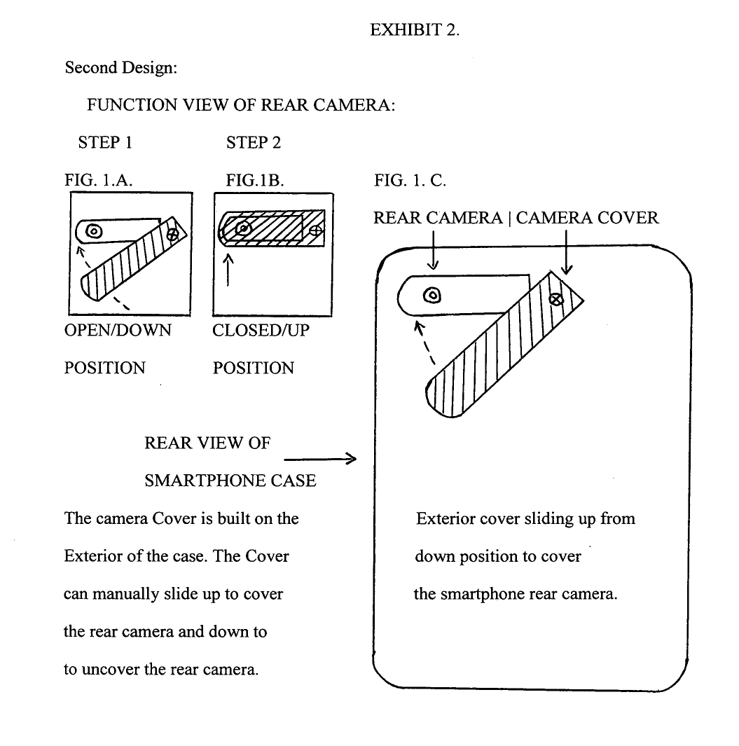

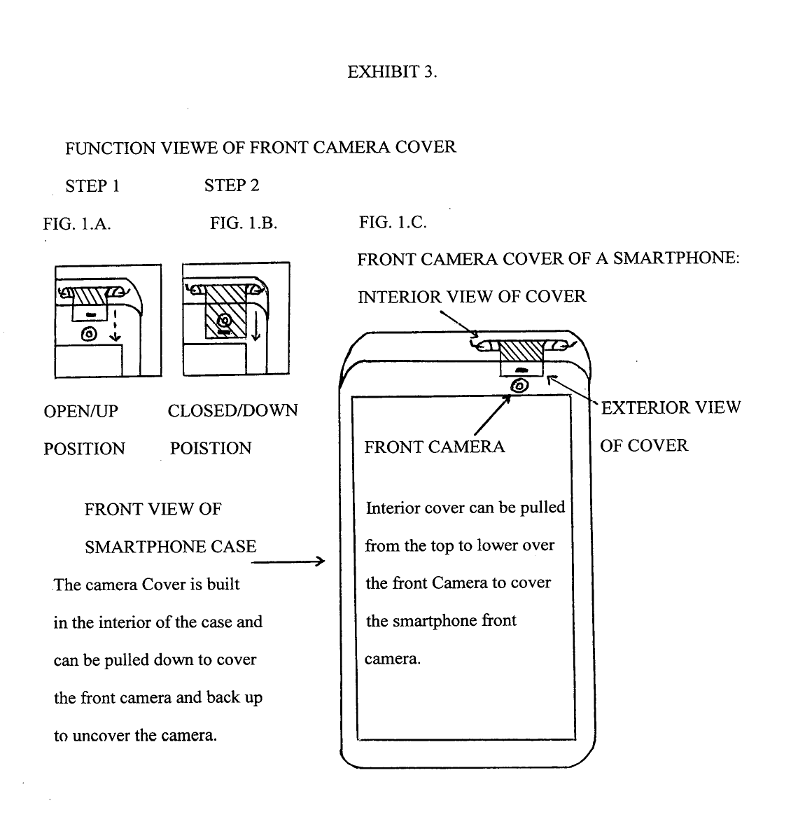

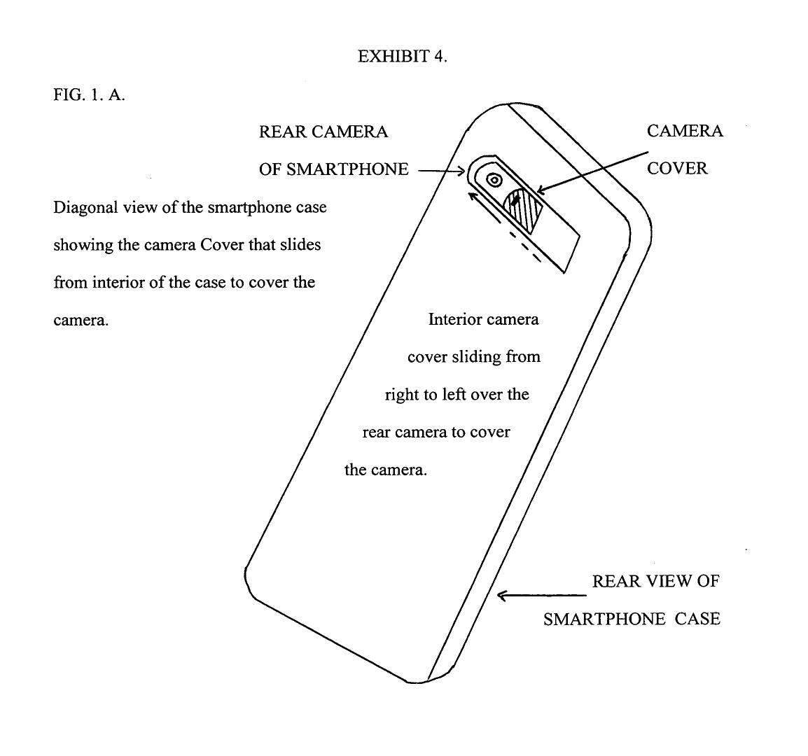

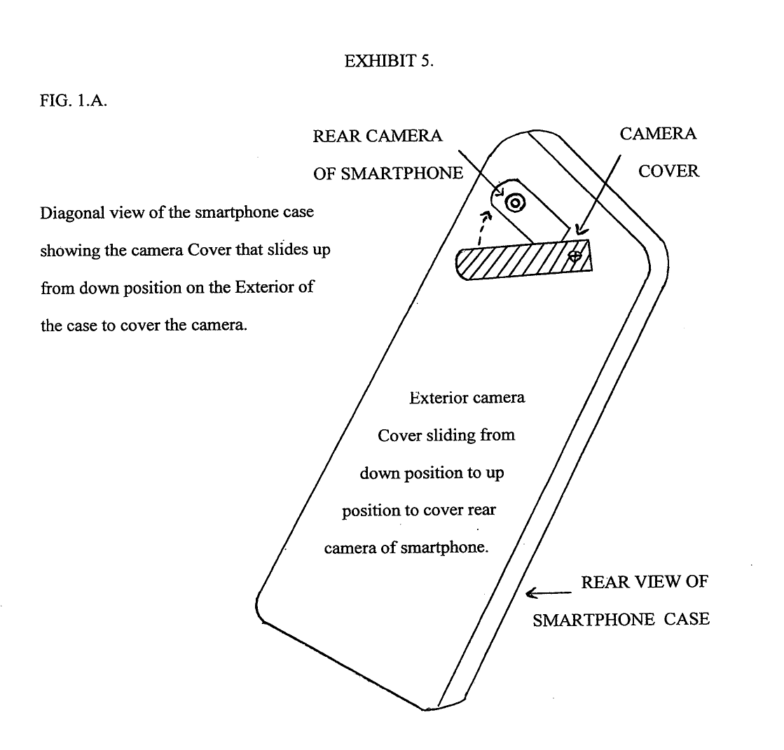

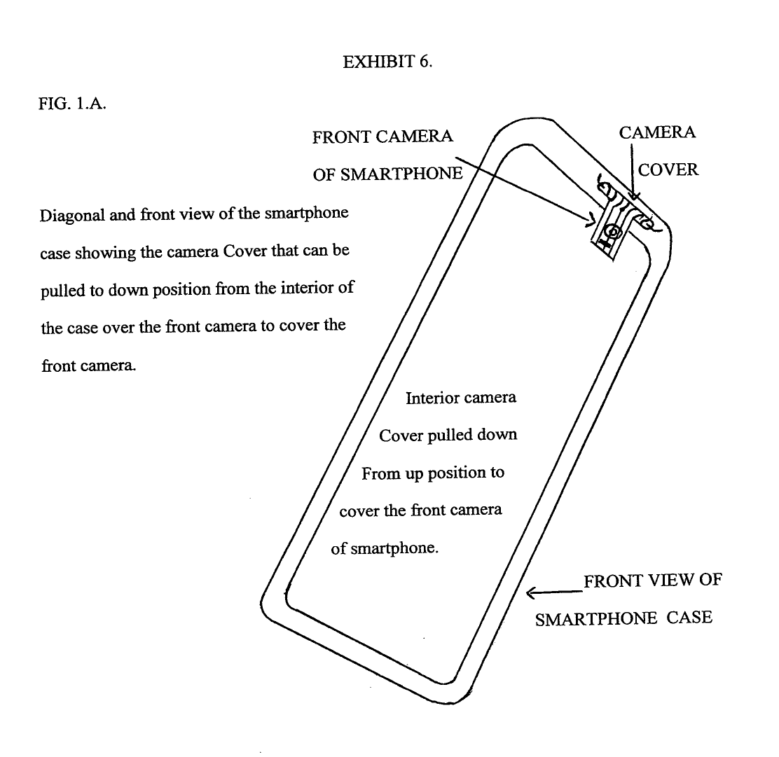

Exhibit 1. FIG. 1. A. First design:

This is the enlarged picture of the rear view camera cover of the smartphone case in an uncovered position. The camera cover from the interior of the smartphone case is in the open or right position.

Exhibit 1. FIG. 1.B.:

This is the enlarged picture of the rear view camera cover of the smartphone case in a closed or covered position. The camera cover from the interior of the smartphone case is manually slid from the right position to the left position to cover the smartphone camera.

Exhibit 1. FIG. 1. C.:

For the rear or back camera of the smartphone, the phone case would have a hard plastic cover by the rear camera sliding from right to left over the rear camera to cover/protect the smartphone's rear camera and slide back to the right to uncover the camera. This cover feature is built on the interior of the smartphone Case by the rear camera and can be manually moved or shifted to cover and uncover the camera.

Exhibit 2. FIG. 1.A. Second Design:

This is the enlarged picture of the rear view camera cover of the smartphone case in an uncovered position. The camera cover from the exterior of the smartphone case is in the open or lowered position.

Exhibit 2. FIG. 1.B.:

This is the enlarged picture of the rear view camera cover of the smartphone case in a closed or covered position. The camera cover from the exterior of the smartphone case is manually shifted or pulled upwards manually from the lowered position to cover the smartphone camera.

Exhibit 2. FIG. 1.C.:

This design camera Cover slides from bottom or down position upwards (Exhibit 2 FIG. 1.A. and 1.B.) to cover the rear camera of the smartphone. This design is an Exterior cover that can be manually lifted up to cover the rear camera or slide down to uncover the rear camera. The phone case can be made of soft or hard plastic.

Exhibit 3. FIG. 1. A.:

This is the enlarged picture of the front view camera cover of the smartphone case in an uncovered position. The camera cover from the interior of the smartphone case is in the open or upward position.

Exhibit 3. FIG. 1.B.:

This is the enlarged picture of the front view camera cover of the smartphone case in a closed or covered/lowered position. The camera cover from the interior of the smartphone case is manually pulled down from the up position to cover the smartphone front camera.

Exhibit 3. FIG. 1.C.:

The smartphone camera cover Case for the front camera would also have a cover, except it would be dropped or pulled down from the interior top section of the case to cover the front camera: Exhibit 3. FIG. 1.A and 1.B. The front cover would be soft plastic that would roll up and down manually around a pin in the interior of the case. The plastic would roll around a half inch rolling pin mounted in the interior of the phone case. The pin to which the plastic camera cover would roll around will be mounted in the upper wall or ceiling of the smartphone case leaving enough space for the pin so as to not interfere with the actual smartphone.

Exhibit 4. FIG. 1.A.: First Design

This is the diagonal rear view of the smartphone case showing the camera cover that slides from the interior of the case from right/open position that can be shifted manually to the left or closed position to cover the camera.

Exhibit 5. FIG. 1.A.: Second Design

This is the diagonal rear view of the smartphone case showing the camera cover from an exterior bottom position that can slide up manually to cover the rear camera of the smartphone.

Exhibit 6. FIG. 1.A.:

This is the diagonal front view of the smartphone case showing the camera cover that can be pulled to down position from the interior of the case over the front camera to cover the front camera for the smartphone.

This specification contains no new matter.

1. I Tamim M. Hessabi hereby claim the idea and design in a smartphone case to cover the front and rear cameras of a smartphone manually with the type of phone Case designed with sliding covers over the smartphone cameras which is either interior or exterior depending on the type of smart phone and the desired case.
